(19) United States
(12) Patent Application Publication
(10) Pub. No.: US 2024/0095637 A1
(43) Pub. Date: Mar. 21, 2024

(54) COLLUSION DETECTION USING MACHINE LEARNING AND SEPARATION OF DUTIES (SOD) RULES

(71) Applicant: SailPoint Technologies, Inc., Austin, TX (US)

(72) Inventor: Jeremy Holovacs, Pensacola, FL (US)

(21) Appl. No.: 18/468,454

(22) Filed: Sep. 15, 2023

Related U.S. Application Data
(60) Provisional application No. 63/408,335, filed on Sep. 20, 2022.

(51) Int. Cl. G06Q 10/0635; G06N 20/00

(52) U.S. Cl. CPC G06Q 10/0635; G06N 20/00

(57) ABSTRACT

Systems and methods are disclosed relating to mechanisms for performing scoped investigations into potential collusion fraud where different sides of an SoD risk are found in different people, and to identify likely cases of such collusion, or at least potentially suspicious behavior that should be carefully audited. Systems and method can utilize ML/AI engines and scoring of data (activities) across various platforms to review not only a person's actions, but the actions of people with which they have relationships. In some embodiments, systems standardize data across multiple platforms and analyze data in light of other data from other users to find patterns associated two or more individuals involved in different parts of an SOD risk.

### TECHNICAL FIELD

This disclosure relates generally to the field of fraud detection and identification of risky behaviors in an organization. In particular, this disclosure relates generally to the field of fraud detection and identification of risky behaviors in an organization between two or more complicit individuals.

### BACKGROUND

In the year 2020, PwC (PricewaterhouseCoopers) estimated that businesses lost $42 billion to fraud in the previous 2 years alone, based upon a survey of over 5000 businesses. The number could be much higher if estimating for undetected incidents. The survey indicated that 47% of all respondents had experienced at least 1 case of fraud in the last 24 months, and 13% had reported losses in excess of $50 million. (see https://www.pwc.com/gx/en/services/forensics/economic-crime-survey.html for more details).

Fraud is a difficult problem to detect and protect against because the perpetrators are usually trusted employees and/or vendors. They know their jobs and usually have a good sense for what type and level of graft can slip by undetected, and what would be easily caught. This is generally mitigated by strict attention to good compliance controls and governance measures. Tools like SailPoint's Access Risk Management (ARM) SoD analysis can easily detect when a company might be at risk by seeing if an employee can perform multiple duties without supervision (for example “create/change a vendor” and “pay a vendor”; an employee with both of these abilities can create a fictitious vendor and cut it a check, which he or she would then cash and collect personally. As these business functions are both part of his or her normal job activities, and likely processed dozens of such requests a day, such activities would rarely gain attention). When such tools are properly used, companies can reduce the risk of fraud by a significant amount.

However, what if one employee can create/change a vendor and his/her colleague in the same department can pay a vendor? Employee #1 could create an imaginary vendor, tell employee #2 to write a large check to this vendor, which could be cashed by one of the two and split. This would not trip any alarms in an SoD analysis, since the risky behavior is distributed between two people and their duties are properly segregated. This is a form of collusion fraud, and it is very difficult to detect; there is a massive amount of multidimensional information that is generally considered just south of “impossible” to make sense of when looking for patterns of fraudulent behavior, and of the things to look for, perhaps the most important is what is not there.

In a 2018 publication by the Association of Certified Fraud Examiners (see https://s3-us-west-2.amazonaws.com/acfepublic/2018-report-to-the-nations.pdf), when 2 people colluded to commit fraud, the median losses to the company more than doubled. When 3 or more people colluded to commit fraud, the median loss was even higher.

One way to detect collusion fraud, is to start with a suspicion of a fraudulent activity between select perpetrators, and work your way back to find evidence of the behavior. Unfortunately, this requires you to already have a pretty good idea that certain individuals have committed the act already. It is not an early discovery and prevention process, but rather a forensic process when damage has been done and may not be recoverable.

The following disclosure describes a mechanism to perform a scoped investigation into potential collusion fraud where different sides of an SoD risk are found in different people, and to identify likely cases of such collusion, or at least potentially suspicious behavior that should be carefully audited. This can potentially save larger companies substantial amounts of money and may be adopted as a risk mitigation control in their suite of such.

### SUMMARY

An embodiment of a method includes training a machine learning (ML) model to recognize patterns in data indicative of collusive behavior of two or more individuals, collecting data relating to activities of a plurality of individuals in an organization, applying the ML model to the collected data to detect one or more pattern anomalies in the collected data that are indicative of collusive behavior of two or more of the plurality of individuals, ranking detected pattern anomalies by risk level to identify potential collusive activities by two or more individuals in the organization, and presenting the identified potential collusive activities to a user over a user interface.

Another embodiment provides a system that includes a processor and a non-transitory, computer-readable storage medium. The computer-readable storage medium includes computer instructions for training a machine learning (ML) model to recognize patterns in data indicative of collusive behavior of two or more individuals, collecting data relating to activities of a plurality of individuals in an organization, applying the ML model to the collected data to detect one or more pattern anomalies in the collected data that are indicative of collusive behavior of two or more of the plurality of individuals, ranking detected pattern anomalies by risk level to identify potential collusive activities by two or more individuals in the organization, and presenting the identified potential collusive activities to a user over a user interface.

Another embodiment provides a non-transitory computer readable medium, comprising instructions for training a machine learning (ML) model to recognize patterns in data indicative of collusive behavior of two or more individuals, collecting data relating to activities of a plurality of individuals in an organization, applying the ML model to the collected data to detect one or more pattern anomalies in the collected data that are indicative of collusive behavior of two or more of the plurality of individuals, ranking detected pattern anomalies by risk level to identify potential collusive activities by two or more individuals in the organization, and presenting the identified potential collusive activities to a user over a user interface.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a flow chart illustrating one example of a process for identifying collusive activities of individuals.

FIG. 2 is a flow chart illustrating one example of a process for developing a ML model.

FIG. 3 is an example of a computer system that may be used in some embodiments of the present technology.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Generally, systems and method can utilize machine learning/artificial intelligence (ML/AI) engines, scoring of data (activities) across various platforms (SAP, Oracle, etc.) to review not only a person's actions, but the actions of people with which they have relationships (e.g., opening of a work order and payment of the work order might be done by 2 different actors, but if done in particular ways, might indicate fraud). In some examples, it is desired to both: (1) standardize data across platforms and (2) analyze data in light of other data from other users. It can be difficult to identify collusion by reviewing the individual activities of users (standard fraud detection typically identifies individual fraud), but collusive fraud where two or more actors are involved is hard to identify. The systems and methods described below can find patterns of two (or more) people involved in different parts of an SOD risk.

This disclosure describes systems and methods that are, in some embodiments, implemented entirely in software, that identify patterns of suspicious behavior between two or more collaborators that would result in a potentially risky situation for a company. Using an SOD rulebook as a blueprint for the risky access, systems and methods train a machine learning (ML) algorithm to incorporate utilization data and scope against it, and look for exclusive patterns of behavior (described in more detail below) that may be an indication of collusive behavior between two or more individuals. Identification of suspicious behavior does not necessarily indicate wrongdoing in and of itself, but it may provide suggestions for additional scrutiny and controls. Determining if the behavior is actually collusion fraud may require additional, targeted investigation.

Without a process of collusion detection, control gaps are much more likely to exist, and it is impractical to dedicate investigation/recovery resources to look for the proverbial needle in the haystack. There may be no obvious evidence or indication of wrongdoing, and therefore it is difficult to justify the expense and time to properly address the potential gap. The systems and methods described in this disclosure generate the evidence necessary to justify the effort.

The concepts described herein can be applied in abstract form to any sufficiently sophisticated enterprise resource planning (ERP) system, and standardized to a true cross-system enterprise-wide scope. As an example, a target company could be a user of an ERP system, employ a robust SoD policy for risk mitigation, and be sizable enough that collusion could be possible. For example, if the accounts payable (AP) department consisted of exactly one AP clerk, the individual will naturally have both sides of the “create/change a vendor” and “pay a vendor” SoD risk and other controls will be in place to mitigate the risks of fraud; this is not a company at risk (at least in this capacity) for collusion fraud. Likewise, if there's exactly one AP clerk that pays vendors, and exactly one that creates vendors, everything in this scenario would look like potential collusion.

If you look at how typical fraud detection mechanisms work, when discussing patterns of behavior, they are typically external to the operations in question. For example, the Association of Certified Fraud Examiners (ACFE) references personal behaviors like living beyond one's means, family issues (divorce, etc.), and financial difficulties as such patterns. However, collusion detection does not require such invasive and qualitative warning signs. Instead, a system can focus on a few key, data-based concepts, as outlined below.

Scope Exclusivity

For two or more colluders to have an expectation of remaining undetected, the scope of their actions must be precise and exclusive. Allowing uninvolved parties to enter the operation dramatically increases the risk of being discovered. In one example (e.g., the create/change a vendor, pay a vendor), the vendor in question must only be created and viewed by exactly two people, representing the two sides of the SoD risk. We want to look for statistically significant cases where the same two or more people work on one target, and nobody but those owning the business functions do.

Low-Impact, High Repetition

Someone intentionally committing fraud via collusion has a vested interest in not being detected. Therefore, they may tend to work within a boundary that will not create undue attention. For example, cutting a check for $10,000 might raise some eyebrows (and mandate risk mitigation measures), but cutting 40 checks for several hundred dollars at a time might not, especially in an environment where payments of that size are commonplace. Here, a system is are going to look for low-impact items (for example, the vendor check value is $300 or less), but with a lot of occurrences (e.g., same vendor, or multiple vendors set up by the same 2 people).

One-Shot Approach

Continuing with the create/change vendor, pay vendor example, in many organizations, there are mitigations in place to regularly review vendors that are periodically paid. The colluders would almost certainly be aware of this. Therefore, another pattern to look for are “throw away” scenarios; one-shot vendor creation, one-time payment, and off the books. Considering the hundreds to tens of thousands of vendor payments that could occur in a large company, detecting this pattern of behavior by manual audit (a typical mitigation) would be very difficult. However, an algorithm for detecting such patterns can make surprisingly quick work of this.

Increasing Frequency Over Time

If the individuals committing fraud believe they have successfully gotten away with it, there is a high likelihood that they will become bolder and greedier over time. A system can look for and identify patterns of increasing impact that do not necessarily keep pace with the company's revenue or payroll.

Collusion “Networking”

Another pattern of behavior to be looking for is a “hub”, where one person in a business function that is part of an SoD risk has multiple “partners”, each with the other side of the risk and operating independently. If one instance is found, depending on the nature of the risk or exploit, this pattern may be widespread. It should be noted that this has a high likelihood of being legitimate behavior. It is only when brought into context with other suspicious behavior that this takes on additional value in collusion detection.

Following is an example of methodologies that may be utilized to implement the systems and methods described above. Other methodologies may also be utilized, as one skilled in the art would understand.

Collecting Data in Scope

The data needed to properly do an analysis for collusion detection can be collected from SAP (or other databases), for example, but SAP does not need to be the only source of data. All the data discussed below could be transformed into a standardized format that other business applications could fit as well, for an ML analysis across an enterprise. While SAP references are used herein, other examples and terminology are also possible, as one skilled in the art would understand.
1. First, a security extract and utilization extract are collected from the SAP (or other) system(s) in question, and used to perform an SoD risk analysis for the company.
2. The system then collects the results from the analysis, and identifies all users that have one side of an SoD risk (exactly one business function) or multiple sides, but have only executed on one side.
3. The users and their associated executed business functions will then be paired with users associated with the other side of an executed business function in SoD risks as defined in the customer's rulebook in a many-to-many relationship. If the SoD risk contains more than 2 business functions, there will be a cartesian product for the many-to-many permutations.
4. Audit records are collected from the SAP system (change documents) for these users, focused on the business functions they are authorized to perform.
5. The change documents will be abstracted to represent a target (in the example case we are referring to above, this would be a vendor) [CDHDR], an action (the business function; in this example, “pay a vendor” and “create/change a vendor”) [TCode], and an impact (usually some form of dollar value but could be scoped to an asset just as easily) [CDPOS]. This data would be associated with the collected user information collected in step 3.
6. When all the data is collected, the system will have a graph of risks, users with one or more business functions associated with the risks (but not all business functions associated with the risk, or at least have not executed on all business functions), their associated risk business function users, and references to scope, actions, and impact that we can then use to perform analysis.

Detecting Scope Exclusivity
1. Once data has been collected and associated, the data is queried to identify when the target is exclusively associated with a specific combination of business function users. If both (all) sides of an SoD risk are met with a discrete set of users, and no other similarly-provisioned users are involved, there is a high likelihood of collusion in this scenario.
2. The likelihood of the risk actually being collusion may be small. We can calculate a “confidence” value by examining how often exclusive targets are handled by single users, and determine the statistical probability that the same users exclusively working against the same target happens often or rarely.

Finding Patterns of Low-Impact, High-Repetition Behavior

In some embodiments, the system can use Machine Learning (ML) to detect pattern anomalies in specifically aggregated data, with a train/test methodology described in the following sections. Assuming enough points of data for a statistical baseline, outliers in 2+standard deviations (this may need to be tuned to reflect the target company's business model) should be noted for elevated scrutiny.

Continuing with the Create/Modify Vendor—Pay Vendor compound risk, the system can aggregate baseline data of actors:
User 1
User 2
Vendor
Cash value
Some unique transaction id

To determine low impact, a parameter can be provided that corresponds to the “cutoff point”, i.e. the dollar value of any particular transaction that would not be subject to increased scrutiny. This may be a “soft” value, not reflecting any policy, but perhaps something that just wouldn't raise eyebrows.

Training data could include information where User1 and User2 were exclusive to a particular vendor or vendors, with a cash value under the cutoff parameter.

This kind of analysis can be fit to multiple types of high-risk multipart transactions, for example, shipping/receiving for a company (where controlled substances/high value merchandise might “fall off the truck”), or Custody of Cash/Accounts Receivable Reconciliation (where inbound cash is reconciled with goods/services rendered) with the same basic pattern.

Trend Analysis of Frequency/Impact Increasing Over Time

In the case of trend analysis to detect increasing frequency or impact, machine learning can be applied, but instead of aggregating on the cash value by vendor and participants, aggregation could be based upon rate/value of rolling total impact (cash value) over time. Outliers here should be where the rate of increase is not commensurate with the rest of the financial activity. For example, if company expenses/income grew 100% year-over-year, but specific sorts of risky transactions grew 150% year over year, this may be an indication of the behavior for which the system is searching.

Collation and Ranking of Results

In some embodiments, the system can apply a heuristic scoring mechanism incorporating all of the above results and identify the highest risks to any particular organization when it comes to collusion fraud, purely based upon the data available.

The resultant report can be presented/delivered to auditors for review, or consumed by the CFO/Comptroller/CEO for investigation, documentation, and potentially mitigation and/or remedial action.

This approach is not foolproof. There is a variable potential for false positives, especially in the cases where (as in the continuing example) an AP clerk might be “assigned” vendors, perhaps based upon location, legal entity, or cost center, or if there is a small department, the likelihood of exclusively dealing with a target increases dramatically. Additionally, it is possible to evade detection by this method by periodically introducing an innocent (or not) third party into the process.

Once this scoped data is collected, the system is not limited to running straightforward queries against it. In-depth statistical analysis can be performed to help identify “hot spots” that might indicate trouble behaviors across multiple targets and multiple users.

Note that, as mentioned above, while the methodology above is described in an exemplary context specific to SAP, the concepts are clearly not. Once the data is collected from SAP (and other systems) and placed into a standardized format, the source of the data becomes irrelevant. This functionality can be expended to other enterprise-class ERP systems (e.g., Oracle, Dynamics, Infor, Workday, PeopleSoft, etc.).

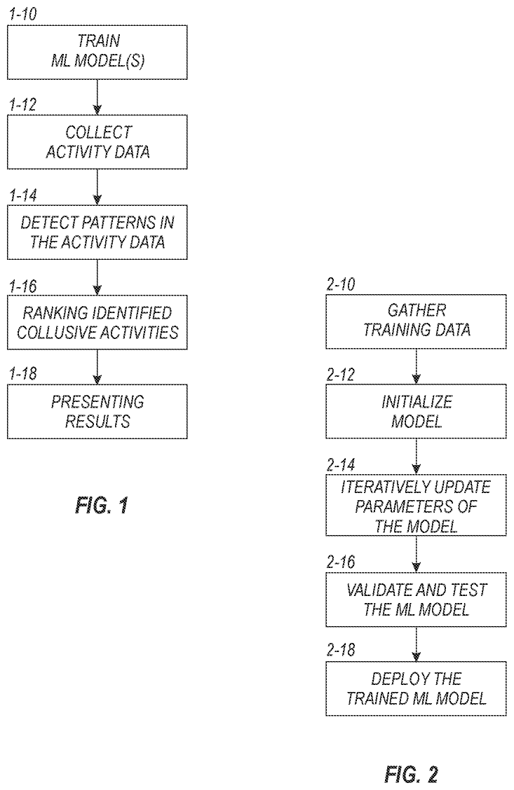

FIG. 1 shows a flow chart of one example of a process for identifying collusive activities of individuals in an organization, as described above. At step 1-10, an ML model is trained. The training of the ML model can be accomplished in any desired manner, as one skilled in the art would understand. An example is described below with respect to FIG. 2. At step 1-20, activity data is collected. As described above, the data can be collected from a plurality of disparate platforms, as desired. For example, data can be collected from a SAP system and/or other systems, such as an enterprise-class ERP system (e.g., Oracle, Dynamics, Infor, Workday, PeopleSoft, etc.). The activity data can relate to activities performed by individuals in an organization (or from outside the organization). At step 1-14, the ML model is applied to the collected data to detect one or more pattern anomalies in the collected data that may be indicative of collusive behavior of two or more individuals. The ML model can be trained to recognize various types of patterns, such as those described above. Other patterns may also be detected, as one skilled in the art would understand. At step 1-16 potential collusive activities identified by the ML model can be ranked and/or scored, as described above. For example, it may be desired to provide an auditor with a report (e.g., step 1-18) of potential collusive activities, along with a ranking and/or score, to help the concentrate the activities posing the highest risks. In some embodiments, the report can be presented to an auditor (or other user) via a user interface.

FIG. 2 shows a flow chart of one example of a process for training an ML model. The training of the ML model can be accomplished in any desired manner, as one skilled in the art would understand. In the example of FIG. 2, training data is gathered a step 2-10. In some examples, training data may include information relating to two or more individuals that exhibit one or more patters, such as those described above. As part of training data collection, the data may need to be processed, as one skilled in the art would understand. At step 2-12, a selected ML model is initialized with random or predetermined parameters, as desired. At step 2-14, the ML model is trained via an iterative training loop to adjust the model's parameters using a selected optimization algorithm. Once adequately trained, the ML model is validated and tested (step 2-16). Finally, the ML model can be deployed (step 2-18), as described above.

Aspects and implementations of the system and method of this disclosure have been described in the general context of various steps and operations. A variety of these steps and operations may be performed by hardware components or may be embodied in computer-executable instructions, which may be used to cause a general-purpose or special-purpose processor (e.g., in a computer, server, or other computing device) programmed with the instructions to perform the steps or operations. For example, the steps or operations may be performed by a combination of hardware, software, and/or firmware.

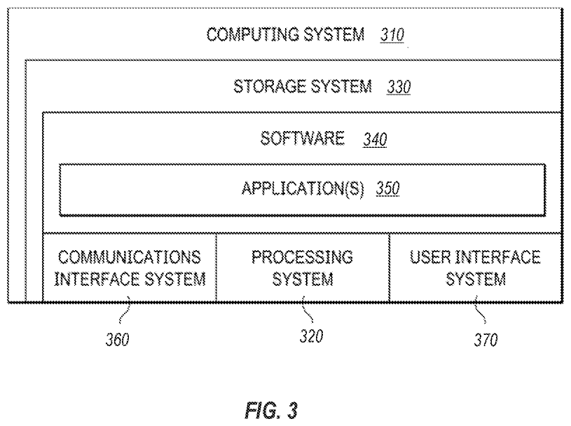

FIG. 3 illustrates computing system 310, which is representative of any system or collection of systems in which the various applications, services, scenarios, and processes disclosed herein may be implemented. For example, computing system 310 may include server computers, blade servers, rack servers, and any other type of computing system (or collection thereof) suitable for carrying out the enhanced collaboration operations described herein. Such systems may employ one or more virtual machines, containers, or any other type of virtual computing resource in the context of supporting enhanced group collaboration.

Computing system 310 may be implemented as a single apparatus, system, or device or may be implemented in a distributed manner as multiple apparatuses, systems, or devices. Computing system 310 includes, but is not limited to, processing system 320, storage system 330, software 340, applications 350, communication interface system 360, and user interface system 370. Processing system 320 is operatively coupled with storage system 330, communication interface system 360, and an optional user interface system 370.

Processing system 320 loads and executes software 340 from storage system 330. When executed by processing system 320 for deployment of scope-based certificates in multi-tenant cloud-based content and collaboration environments, software 340 directs processing system 320 to operate as described herein for at least the various processes, operational scenarios, and sequences discussed in the foregoing implementations. Computing system 310 may optionally include additional devices, features, or functionality not discussed for purposes of brevity.

Referring still to FIG. 3, processing system 320 may comprise a micro-processor and other circuitry that retrieves and executes software 340 from storage system 330. Processing system 320 may be implemented within a single processing device, but may also be distributed across multiple processing devices or sub-systems that cooperate in executing program instructions. Examples of processing system 320 include general purpose central processing units, application specific processors, and logic devices, as well as any other type of processing device, combinations, or variations thereof.

Storage system 330 may comprise any computer readable storage media readable by processing system 320 and capable of storing software 340. Storage system 330 may include volatile and nonvolatile, removable and non-removable media implemented in any method or technology for storage of information, such as computer readable instructions, data structures, program modules, or other data. Examples of storage media include random access memory, read only memory, magnetic disks, nonvolatile memory, battery backed memory, Non-Volatile DIMM memory, phase change memory, memristor memory, optical disks, flash memory, virtual memory and non-virtual memory, magnetic cassettes, magnetic tape, magnetic disk storage or other magnetic storage devices, or any other suitable storage media.

In addition to computer readable storage media, in some implementations storage system 330 may also include computer readable communication media over which at least some of software 340 may be communicated internally or externally. Storage system 330 may be implemented as a single storage device, but may also be implemented across multiple storage devices or sub-systems co-located or distributed relative to each other. Storage system 330 may comprise additional elements, such as a controller, capable of communicating with processing system 320 or possibly other systems.

Software 340 may be implemented in program instructions and among other functions may, when executed by processing system 320, direct processing system 320 to operate as described with respect to the various operational scenarios, sequences, and processes illustrated herein. For example, software 340 may include program instructions for directing the system to perform the processes described above.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 340 may include additional processes, programs, or components, such as operating system software, virtual machine software, or application software. Software 340 may also comprise firmware or some other form of machine-readable processing instructions executable by processing system 320.

In general, software 340 may, when loaded into processing system 320 and executed, transform a suitable apparatus, system, or device (of which computing system 310 is representative) overall from a general-purpose computing system into a special-purpose computing system. Indeed, encoding software on storage system 330 may transform the physical structure of storage system 330. The specific transformation of the physical structure may depend on various factors in different implementations of this description. Examples of such factors may include, but are not limited to, the technology used to implement the storage media of storage system 330 and whether the computer-storage media are characterized as primary or secondary storage, as well as other factors.

For example, if the computer readable storage media are implemented as semiconductor-based memory, software 340 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 360 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 370 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 370. In some cases, the input and output devices may be combined in a single device, such as a display capable of displaying images and receiving touch gestures. The aforementioned user input and output devices are well known in the art and need not be discussed at length here. In some cases, the user interface system 370 may be omitted when the computing system 310 is implemented as one or more server computers such as, for example, blade servers, rack servers, or any other type of computing server system (or collection thereof).

User interface system 370 may also include associated user interface software executable by processing system 320 in support of the various user input and output devices discussed above. Separately or in conjunction with each other and other hardware and software elements, the user interface software and user interface devices may support a graphical user interface, a natural user interface, an artificial intelligence (AI) enhanced user interface that may include a virtual assistant or bot (for example), or any other type of user interface, in which a user interface to an imaging application may be presented.

Communication between computing system 310 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. In any of the aforementioned examples in which data, content, or any other type of information is exchanged, the exchange of information may occur in accordance with any of a variety of well-known data transfer protocols.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A method, comprising:
training a machine learning (ML) model to recognize patterns in data indicative of collusive behavior of two or more individuals;
collecting data relating to activities of a plurality of individuals in an organization;
applying the ML model to the collected data to detect one or more pattern anomalies in the collected data that are indicative of collusive behavior of two or more of the plurality of individuals;
ranking detected pattern anomalies by risk level to identify potential collusive activities by two or more individuals in the organization; and
presenting the identified potential collusive activities to a user over a user interface.

2. The method of claim 1, wherein the patterns indicative of collusive behavior include instances where first and second individuals each have responsibilities with an exclusive scope.

3. The method of claim 1, wherein the patterns indicative of collusive behavior include instances where activities of first and second individuals is highly repetitive.

4. The method of claim 1, wherein the patterns indicative of collusive behavior include instances where first and second individuals engage in a one-time activity.

5. The method of claim 1, wherein the patterns indicative of collusive behavior include instances where given activities of first and second individuals increases in frequency over time.

6. The method of claim 1, wherein the patterns indicative of collusive behavior include instances where a first individual engages in a given activity with a plurality of other independent individuals.

7. The method of claim 1, wherein the collected data is collected from a plurality of disparate platforms.

8. The method of claim 7, further comprising standardizing the format of the collected data from the plurality of disparate platforms.

9. The method of claim 1, wherein the ML model is trained using training data, wherein the training data includes data relating to activities of individuals engaging in collusive activities.

10. An system, comprising:
a processor;
a non-transitory, computer-readable storage medium, including computer instructions for:
training a machine learning (ML) model to recognize patterns in data indicative of collusive behavior of two or more individuals;
collecting data relating to activities of a plurality of individuals in an organization;
applying the ML model to the collected data to detect one or more pattern anomalies in the collected data that are indicative of collusive behavior of two or more of the plurality of individuals;
ranking detected pattern anomalies by risk level to identify potential collusive activities by two or more individuals in the organization; and
presenting the identified potential collusive activities to a user over a user interface.

11. The system of claim 10, wherein the patterns indicative of collusive behavior include instances where first and second individuals each have responsibilities with an exclusive scope.

12. The system of claim 10, wherein the patterns indicative of collusive behavior include instances where activities of first and second individuals is highly repetitive.

13. The system of claim 10, wherein the collected data is collected from a plurality of disparate platforms.

14. The system of claim 13, further comprising standardizing the format of the collected data from the plurality of disparate platforms.

15. A non-transitory computer readable medium, comprising instructions for:
training a machine learning (ML) model to recognize patterns in data indicative of collusive behavior of two or more individuals;
collecting data relating to activities of a plurality of individuals in an organization;
applying the ML model to the collected data to detect one or more pattern anomalies in the collected data that are indicative of collusive behavior of two or more of the plurality of individuals;
ranking detected pattern anomalies by risk level to identify potential collusive activities by two or more individuals in the organization; and
presenting the identified potential collusive activities to a user over a user interface.

16. The non-transitory computer readable medium of claim 15, wherein the patterns indicative of collusive behavior include instances where first and second individuals engage in a one-time activity.

17. The non-transitory computer readable medium of claim 15, wherein the patterns indicative of collusive behavior include instances where given activities of first and second individuals increases in frequency over time.

18. The non-transitory computer readable medium of claim 15, wherein the patterns indicative of collusive behavior include instances where a first individual engages in a given activity with a plurality of other independent individuals.

19. The non-transitory computer readable medium of claim 15, wherein the collected data is collected from a plurality of disparate platforms.

20. The non-transitory computer readable medium of claim 19, further comprising standardizing the format of the collected data from the plurality of disparate platforms.
